(19) United States
(12) Patent Application Publication
(10) Pub. No.: US 2026/0261039 A1
(43) Pub. Date: Sep. 3, 2026

(54) Bicycle, in Particular an Electric Bicycle, and Bicycle Antenna

(71) Applicant: MA Micro Limited, London (GB)

(72) Inventors: Olivier Hébert, London (GB); Jiun Peng Gu, London (GB); Mao-Chieh Tang, London (GB); Chien I Chen, London (GB)

(21) Appl. No.: 18/846,356

(22) PCT Filed: Mar. 14, 2023
(86) PCT No.: PCT/NL2023/050130

§ 371 Date: Sep. 12, 2024

(30) Foreign Application Priority Data
Mar. 15, 2022 (NL) 2031284

(51) Int. Cl. B62J 45/10; B62K 19/40

(52) U.S. Cl. CPC H01Q 1/325; H01Q 1/2208

(57) ABSTRACT

The invention relates to a bicycle, in particular an electric bicycle. The invention also relates to an antenna system for use in a bicycle according to the invention. The invention furthermore relates to antenna device for use in a bicycle according to the invention.

### CROSS-REFERENCE TO RELATED APPLICATIONS

This application is the United States national phase of International Patent Application No. PCT/NL 2023/050130 filed Mar. 14, 2023, and claims priority to The Netherlands Patent Application No. 2031284 filed Mar. 15, 2022, the disclosures of which are hereby incorporated by reference in their entireties.

### BACKGROUND OF THE INVENTION

### Field of the Invention

The invention relates to a bicycle, in particular an electric bicycle. The invention also relates to an antenna system for use in a bicycle according to the invention. The invention furthermore relates to antenna device for use in a bicycle according to the invention.

### Description of Related Art

Over the last 150 years, the bicycle has evolved to become one of the most efficient means of transportation in terms of conversion of energy into distance travelled. The efficiency of the bicycle has also been optimized to minimize the effort required by the rider. For instance, most modern bicycles include an efficient gear system to minimize rider effort. To further reduce the amount of human effort required to propel a bicycle, a variety of electric bicycles (e-bikes) have been introduced, wherein use is made of an electromotor as auxiliary power source to assist the manpowered pedalling process. These developments have resulted in faster bicycles, which facilitates bicycling at high speeds. The presence of onboard electrical power moreover facilitates the presence and powering of electronic components, such as lights, and moreover allows the bicycle to be able to communicate with an external device, such as a smartphone, to monitor, and optionally, control specific bicycle settings. The communication can be wired or wireless by using a bicycle antenna.

However, the existing antenna solutions used in bicycles exhibit a rather poor antenna performance.

### SUMMARY OF THE INVENTION

It is an object of the invention to provide a bicycle, in particular an electric bicycle, provided with an improved antenna system.

It is another object of the invention to provide a bicycle, in particular an electric bicycle, provided with an improved antenna system exhibiting an improved antenna performance.

It is a further object of the invention to provide a bicycle, in particular an electric bicycle, provided with an improved antenna system which can be manufactured in a rather efficient and/or environmental friendly manner.

At least one of these objects can be achieved by providing a bicycle, in particular an electric bicycle, comprising:
a bicycle frame,
at least one antenna system at least partially mounted, directly or indirectly, to said bicycle frame, wherein the antenna system comprises at least one antenna device comprising:
   at least one support substrate,
   at least one conductive radiator applied onto said substrate,
   a shielding structure covering said at least one conductive radiator, wherein said shielding structure is substantially free of conductive material, and wherein an outer side of the shielding structure facing away from said conductive radiator is at least partially, and preferably substantially entirely, exposed to the environment.

The antenna system used in the bicycle according to the invention is configured such that the conductive radiator(s) of the antenna device(s) used, is/are no (longer) covered by metallic and/or carbon frame parts or other conductive bicycle parts, which prevents undesired interference with adjacent bicycle parts, and which allows the antenna device(s), and hence the antenna system(s), to transmit and/or receive signals, such as data, in unobstructed manner, which significantly increases the performance of the antenna device(s) and the antenna system(s). By leaving the radiator(s) uncovered by a conductive layer, the antenna gain, being a measure of the maximum effectiveness with which the antenna device can radiate power delivered to it by the transmitter (of the bicycle) towards an external target, can be improved significantly. In order to protect and shield the radiator(s), the radiator(s) is/are covered by at least one (non-conductive) shielding structure. This will prevent damaging and breakage of the radiator(s), which will secure the durability and reliability of the radiator(s), and hence of the antenna device(s) and the antenna system(s) as such. With exposure to the environment is meant, exposure to the atmosphere (environment) surrounding the bicycle. The antenna system, in particular the antenna device(s) may be exposed to the atmosphere (environment) surrounding the bicycle in a direct and/or indirect manner. Here, direct may be understood as the antenna device being visible from the atmosphere (environment) surrounding the bicycle. Indirectly should be understood as the antenna device not being visible, e.g., cover by a thin top layer or shielding layer and/or shielding structure, said top layer not being composed out of a conductive material. Said thin top layer may for example be a thin layer of paint provided on an exterior surface.

The antenna system used in the bicycle may serve different purposes. For example, the antenna system may be used, for example, to allow remote tracking of the bicycle, and/or to allow wireless recognition of the bicycle by an external device (or vice versa), such as a smart phone or (electronic) smart bicycle key, and/or to allow wireless data and/or voice communication with an external device, such as a smartphone or external computer. Hence, the antenna system used in the bicycle according to the invention may be adapted for communication with a system for determining its own position. Further, the antenna may be adapted for communicating information on the position to an external receiver, such as a smartphone, a computer, a tablet, or a smartwatch. The antenna may be adapted for tracking the bicycle frame so that, for example, the owner, insurance company or the police can read the position of the bicycle frame, by the antenna being able to receive information on the position from a remote system for determining the position, such as a GPS, and transmit information to a remote receiver, such as a smartphone. The antenna may be an antenna for tracking the position of the bicycle frame in real time. Further examples, communication protocols, and embodiments will be described below.

Preferably, the antenna system is configured to operate in at least one wireless communication system selected from the group including: Bluetooth, Infrared (IR), 2.4 GHZ Bluetooth, 2.4 GHz IEEE 802.11b/g, 5 GHz IEEE 802.11a, Hyperlan, IEEE 802.11 (WiFi), ultra wide band (UWB), LTE, LTE-M, NB-IOT, NFC, RFID, WiMAX, ZigBee, ZigBee at 860 MHz, ZigBee at 915 MHz, GPS, GPS at 1.575 GHz, GPS at 1.227 GHz, Galileo, GSM-900, DCS-1800, UMTS, CDMA, DBA, WLAN, WLAN at 2.4 GHz and/or 5 GHz, PCS 1900, KPCS, WCDMA, DAB, 2.4-2.483 GHz band, and 2.471-2.497 GHz band. It is imaginable that at least one antenna device is configured to operate in a plurality of the abovementioned communication systems. For example, it is imaginable that an antenna device is configured to operate both in a 2.4 GHz frequency band and in a 5 GHz frequency band. It is imaginable that the antenna system comprises a plurality of antenna devices.

Different antenna devices may be configured to operate in/with different wireless communication systems. For example, it is imaginable that a first antenna device is configured to act as Bluetooth antenna, while a second antenna device is configured to act as GPS antenna, and/or while a third antenna device is configured to act as LTE-M antenna and/or as NB-IoT antenna, and/or while a fourth antenna device is configured to act as GSM antenna. LTE-M (LTE-MTC [Machine Type Communication]), which includes eMTC (enhanced Machine Type Communication), is a type of low power wide area network (LPWAN) radio technology standard (developed by 3GPP) to enable a wide range of cellular devices and services (specifically, for machine-to-machine and Internet of Things applications). Narrowband Internet of things (NB-IoT) is a low-power wide-area network (LPWAN) radio technology standard (also developed by 3GPP). Zigbee is an IEEE 802.15.4-based specification for a suite of high-level communication protocols used to create personal area networks with small, low-power digital radios, which makes it suitable to be used in bicycles. Typically, the technology defined by the Zigbee specification is intended to be simpler and less expensive than other wireless personal area networks (WPANs), such as Bluetooth or more general wireless networking such as Wi-Fi. It is imaginable that at least one pair of at least two antenna devices is configured to act a MIMO pair (multiple-input and multiple-output) to multiply the capacity of a radio link using multiple transmission and receiving antenna devices to exploit multipath propagation. In this manner, data signals can be received and sent simultaneously over the same radio channel. In case a plurality of MIMO pairs is used, the antenna system performance is preferably further improved by applying a combination of differently polarized (horizontally and vertically polarized) antenna devices (or radiators thereof) for enabling best isolation between separate MIMO pairs. It is imaginable that in between two adjacent antenna devices at least one isolating structure is positioned, such as an electromagnetic band gap (EBG) structure to increase that data rate and to maximize the coverage range of the antenna system as such.

It is conceivable that at least one antenna device is linearly polarized. Preferably, at least one antenna device is horizontally polarized. It is also conceivable that at least one antenna device is vertically polarized. Yet alternatively the at least one antenna device may have a slant polarization, such as under an angle of 45 degrees with respect to the vertical and/or horizontal plane. It is also imaginable that the at least one antenna device is circularly polarized and/or elliptically polarized, such as left-hand circular polarization and/or right-hand circular polarization. Polarization may be understood as the plane in which the electric wave vibrates. Preferably, the polarization of the at least one antenna device is designed to correspond with an incoming signal which said antenna device may receive.

Preferably, the outer side of the-typically relatively thin-shielding structure is substantially positioned flush with an adjacent outer surface of (the frame of) the bicycle.

This position commonly leads to a preferred balance between on the one side providing sufficient protection to the shielding structure, to the radiator(s) covered by said shielding structure, and to the antenna device(s) as such, and on the other hand improving the antenna performance as much as possible. Preferably, the shielding structure comprises a shielding layer, said shielding layer comprises at least one dielectric layer, such as a film, a sticker, and/or a coating, and/or wherein the shielding layer comprises a laminate of dielectric layers. Said shielding layer may also be formed by a lacquer layer and/or a paint layer provided onto the bicycle. Hence, covering the visible antenna system. Preferably, the bicycle frame is at least partially, more preferably substantially, made of metal, preferably aluminium, such as brushed metal, in particular brushed aluminium, optionally coated with a coloured and/or protective coating. Although a carbon fibre-based frame is also an option, a metal frame is typically preferred from a financial point of view. Since a metal frame may act as a Faraday cage, which may affect the antenna performance when the antenna is entirely positioned within said cage, it is also for this reason, in case a metal frame is applied, favourable that the shielding structure is substantially positioned flush with the adjacent bicycle frame section(s). This prevents that the antenna devices are covered by metal frame part, which secures a satisfying antenna performance.

According to a preferred embodiment the bicycle, in particular the antenna system, comprises a plurality of antenna devices. This may allow for a variety of functionalities to be fulfilled simultaneously. Hence, the antenna devices may function parallelly. Preferably, the bicycle, in particular the antenna system, comprises a plurality of antenna devices, wherein at least two antenna devices are mounted to different parts of the bicycle. This may prevent negative interference between antenna devices, in particular in case they are polarized differently. It is also conceivable that the bicycle, in particular the antenna system, comprises a plurality of antenna devices, wherein at least two antenna devices are mounted to the same part of the bicycle. The same part of the bicycle may be understood as the antenna devices being located in close proximity of each other on a same components, such as a frame part. It is imaginable that the bicycle, in particular the antenna system, comprises a plurality of antenna devices, wherein at least two antenna devices share a common support substrate (shared support substrate), and wherein the radiators of the at least two antenna devices are preferably situated in the same plane. This may allow each of the antenna devices to emit is a predefined and corresponding direction. This allows for placing at least some of the antenna devices in substantially the same direction to ensure for qualitative emittance of signals. Preferably, at least two, preferably each, of said plurality of antenna devices sharing the same support substrate are configured to operate in different frequency bands and/or may serve different purposes. In case of such a shared support structure, simultaneously used by a plurality of antenna device, it is favourable in case the radiators of said plurality of antenna devices sharing the same support substrate are positioned in line with each other. In this manner an elongated array of antenna devices is realized which can, for example, by efficiently be applied in an elongated frame tube, such as a head tube, top tube, seat tube, and/or down tube of a bicycle frame of the bicycle according to the invention. Typically, said frame tube is provided with a elongated frame opening for insertion of the antenna system and/or antenna device(s). Preferably, the bicycle frame is at least partially, more preferably substantially, made of metal.

Preferably at least one antenna device is at least partially mounted directly to said bicycle frame, wherein at least a part of said antenna device is preferably at least partially accommodated by said bicycle frame. It is imaginable that at least a part of the support substrate of at least one antenna device is accommodated, at least partially, inside a part of the bicycle frame. As such, the exterior of the antenna device may be substantially flush with the bicycle frame. This allows for a more compact packaging of the antennas. It is conceivable that a part of at least one antenna device makes integral part of said bicycle frame. As such, it may be less likely that the antenna device(s) are damaged during installation of the antenna device as such since they are integral part thereof. Preferably, the bicycle frame is at least partially composed a conductive material, in particular metal. If the frame is composed out of metal it is of benefit that the antenna device is at least partially exposed, such that Faraday's cage is prevented, since the bicycle frame being a hollow metal conductor typically constitutes a good Faraday shield. This may limit the emittance of the signal significantly.

According to a beneficial embodiment the bicycle, the bicycle comprises a bicycle control unit, and wherein at least one antenna device is at least partially mounted directly to said control unit and/or integrated with said control unit, and/or wherein the control unit is mounted to and/or accommodated by the support substrate of at least one antenna device. Preferably, the bicycle comprises at least one component mounted to said bicycle frame, and wherein at least one antenna device is at least partially mounted directly to said component, wherein at least a part of said antenna device is preferably at least partially accommodated by and/or mounted to said component. At least one tube of the bicycle frame may comprise at least one opening configured to receive one or more components, in particular a bicycle control unit. Said opening may define at least a part of an accommodating space for accommodating at least a part of the component therein, in particular the bicycle control unit. It is imaginable that the component is a component chosen from the group consisting of: a headlight, a taillight, a stem, a handlebar, a kickstand, a seat post, a brake lever, a shift lever, a saddle, a bicycle control unit, and/or a rechargeable battery. Preferably, at least a part of at least one antenna device makes integral part of said component. It is for example conceivable that the support substrate is formed by a body of the component. Preferably, said support substrate is at least partially composed out of a (electrically) non-conductive material (dielectric material). Hence, a housing of e.g., the bicycle control unit may be composed out of material suitable for forming a support substrate for the antenna device. This may allow for a tighter packaging. It is imaginable that an exterior surface of the component, in particular the bicycle control unit, is substantially flush (i.e. aligned) with a local adjacent outside surface of a frame tube. Preferably, the bicycle control unit comprises at least one direct connection with at least one conductive radiator through, preferably by using at least one through-hole via, the housing and/or a support substrate, of the bicycle control unit. Another benefit may be, in case the antenna system comprises a plurality of antenna devices, that each of the antenna devices may be provided on a different component. As such, the antenna device may be designed such as to fit on a specific product, preferably to co-act with said product. Preferably, at least a part of at least one antenna device is mounted to and/or makes part of a bicycle control unit.

Preferably, at least one support substrate of at least one antenna device is a moulded substrate. Said moulded substrate may e.g., be a moulded component, such as a housing of a bicycle control unit and/or a housing of a rechargeable battery. It is imaginable that the moulded substrate comprises at least one polymer resin, preferably chosen from the group consisting of: PC, acrylonitrile-butadiene-styrene copolymer (ABS), LCP, and mixtures thereof. The polymer used may be a solid polymer or a foamed polymer. These polymers have proven to be suitable for the production of the moulded products and additionally functioning as a support substrate. Preferably, said at least one polymer resin incorporates at least one metal-containing substance, preferably a copper-containing substance, and/or preferably a substance chosen from the group consisting of: Cu₂(OH)PO₄, or a metal oxide containing substance, such as CuO, Cr₂O₃, or CuO·Cr₂O₃. This may allow for easy application of the at least one conductive radiator of the antenna device onto the moulded substrate.

Preferably, at least one support substrate, more preferably a shared support substrate, accommodates at least one speaker device, wherein said at least one support substrate, preferably said shared support substrate, is provided with a plurality of perforations allowing sound signals emitted by said at least one speaker device to be emitted to an external environment of the bicycle. This provides the support structure with additional functionality, which is in favour of miniaturization of the bicycle components applied in the bicycle in order to save weight and space.

Preferably, at least one conductive radiator of at least one antenna device is deposited and/or printed and/or metallized and/or plated onto said substrate. To this end the substrate may be moulded, but may also be composed and/or fabricated by alternative methods for providing a suitable substrate. It is conceivable that at least one radiator of at least one antenna device is at least partially composed of copper and/or nickel and/or gold. At least one radiator of at least one antenna device may be either a single layer radiator or a multilayer radiator. In this latter case, preferably two, three, or more different metal layers are stacked onto each other, e.g. a gold layer on top of a nickel layer. Preferably at least one conductive radiator of at least one antenna device is substantially flat. Preferably each radiator has thickness of between 1 and 20 micron. This limited thickness will be in favour of miniaturization of the antenna device(s).

It is imaginable that at least one antenna device comprises at least two conductive radiators. The number of conductive radiators may define the characteristics of the antenna system, such that a predefined pattern or signal may be achieved. Preferably, the number of conductive radiators is designed in relation to a specific functionality that requires signals to be emitted and/or received. It is imaginable that at least one conductive radiator of at least one antenna device is formed by a conductive layer. At least one conductive radiator of at least one antenna device may be curved and/or angular. Preferably, at least one radiator has a 3D geometry. More preferably, at least one support structure has a 3D surface onto which said at least one radiator is applied, which (consequently) has a corresponding and/or matching 3D geometry. Such a 3D geometry may be beneficial to improve the omnidirectionality (omnidirectional performance) of the antenna device. It is also conceivable that the antenna system, in particular the antenna device comprises at least one parasitic element and/or a passive radiator, wherein said parasitic element and/or passive radiator is configured for enhancing and/or modifying, preferably passively, the emitted signal. The parasitic and/or passive radiator may for example direct the waves emitted into a beam inn a single direction, increasing the directivity of the antenna system. According to a preferred embodiment each antenna device comprises a conductive ground plane mounted to the support substrate at a side of the support substrate facing away from the at least one radiator. Said ground plane is preferably composed out of a substantially flat conductive area, at least in a region of the antenna device. Said conductive ground plane may additionally function as a ground for the electronic components and/or the antenna as such. The smallest critical diagonal is preferably at least a quarter of the size of the radius of the wavelength of the antenna. It is not necessary for the conductive ground plane to form a continuous surface, and may thus alternatively be formed by wires and/or conductive lines with a size exceeding a quarter of the size of the radius of the wavelength of the antenna. Preferably each antenna device, in particular each conductive radiator, is connected to a feeding point. The feeding point may connect the transmitter and/or receiver to the antenna.

Preferably, at least one antenna device forms a moulded interconnect device (MID). A MID antenna device comprises a polymer based, preferably thermoplastic based, support structure manufactured with injection moulding with one or more integrated conductive traces (conductive radiators) on its surface. By using this MID technology for manufacturing at least a part of at least one antenna device, a three-dimensional thermoplastic or thermosetting carrier (i.e. the support structure) is created, typically in which conductive metal surfaces are integrated. By using a MID antenna device, connectors, cables and spacers, and even a PCB (printed circuit board), can be omitted, which eliminates space and allows miniaturizing the antenna device. This leads to a weight saving, and consequently an energy saving during use of the bicycle. Hence, a MID antenna device integrates electrical and mechanical elements, which can be designed in almost any shape. The compactness of the antenna system can further be increased in case at least two, preferably each, of said plurality of antenna devices share said support substrate, and together form a single moulded interconnect device (MID). MIDs are preferably manufactured by using laser direct structuring (LDS), although printing and two-shot moulding (using two different polymers, wherein only one polymer is platable) followed by electroless plating to position-selectively apply the radiators. Preferably, at least one antenna device, in particular at least one MID antenna device, is at least partially made by means of laser direct structuring (LDS). Preferably, at least two, preferably each, of said plurality of antenna devices, in particular MID antenna devices, sharing said support substrate, are at least partially made by means of laser direct structuring (LDS).

Preferably, at least one antenna device is at least partially made by means of laser direct structuring (LDS). By means of laser activation a chemical reaction may be initiated to form fine metal particles on the laser-treated surface. In addition to metal nuclei being formed, the laser-treated portion may be roughened. This allows copper and/or other metal traces to be deposited onto this laser-treated surface. The metal lines may be formed by means of electroless plating, which may as such deposit a copper or other metal layer on said laser treaded part. Here, it is imaginable and typically preferred that at least one radiator of at least one antenna device is at least partially embedded in the support substrate. The radiator is hereby applied in a laser created recessed portion (channel or cavity) of the outer surface of the support structure. It is conceivable that at least one support substrate comprises at least one through-hole via, and/or at least one contact pad, and/or at least one feed line, preferably made by means of laser direct structuring (LDS). This LDS means a laser direct patterning method which can form one or more electrically conductive patterns, and here for example radiators, by using an electroless plating after directly patterning a circuit on a plastic moulded product (e.g., top housing frame 602, FIG. 6A). The LDS process may have an advantage that a conducting pattern of various 3D shapes may be implemented by directly patterning the circuit on a plastic product by using a laser. During the LDS process, a metal organic compound contained within the support substrate is formed as a plating seed by a laser reaction. The energy of a laser decomposes a chemical coupling of the metal organic compound of the support substrate by a photochemical reaction, and a metallic element is formed only in a laser-patterned portion to thus serve as a plating seed at the time of electroless plating to deposit the radiator(s) and/or other metallic layers onto said plating seed, which leads to a strong mechanical coupling between a plating layer and the support substrate. Here, the support substrate may be at least partially, or entirely, composed of a Laser Direct Structuring (LDS) material (i.e. a polymer enriched with a metal (oxide) organic compound). The polymer used may e.g. comprise polycarbonate (PC), acrylonitrile-butadiene-styrene (ABS), epoxy resin, bismaleimide resin, a thermosetting resin, and/or mixtures thereof. In other implementations, housing frame 602 serves as an LDS substrate containing a blend of PC and PC-ABS for internal or external antenna fabrication. Preferably, the LDS material used to at least partially compose the support substrate may comprise a thermosetting resin, a non-conductive metal compound that forms a metal nucleus upon irradiation with active energy rays, and optionally an inorganic filler, and optionally a coupling agent. Examples of such non-conductive metal compound can include one or more selected from the group consisting of (i) a spinel-type metal oxide, (ii) a metal oxide having two or more transition metal elements in groups adjacent to each other, the groups being selected from groups 3 to 12 of the periodic table, and (iii) a tin-containing oxide. Further, the coupling agent can include one or more selected from the group consisting of mercaptosilane, aminosilane, and epoxysilane. As the thermosetting resin, for example, one or two or more selected from the group consisting of an epoxy resin, a phenol resin, an oxetane resin, a (meth) acrylate resin, an unsaturated polyester resin, a diallyl phthalate resin, and a maleimide resin can be included. Examples of the inorganic filler include one or two or more inorganic fillers selected from the group consisting of silica including, for example, molten silica such as molten crushed silica and molten spherical silica, and crystalline silica, alumina, aluminium hydroxide, silicon nitride, and aluminium nitride. Among these, as the inorganic filler, silica such as molten crushed silica, molten spherical silica, and crystalline silica is preferably used, and molten spherical silica is more preferably used. By using the spherical inorganic filler, it is possible to improve the dispersibility of the thermosetting resin composition.

According to an advantageous embodiment of the present invention the bicycle comprises at least two wheels connected to said bicycle frame, at least one an electric motor configured to drive at least one wheel, wherein the first bicycle control unit and/or the second bicycle control unit is configured to control, directly or indirectly, said at least one electric motor. Preferably, the bicycle further comprises at least one rechargeable battery attached to and/or accommodated within the bicycle frame, wherein said battery is configured to store at least a part of the energy to be supplied to the at least one electric motor. To this end said battery is connected, directly or indirect, to said motor and to at least one bicycle control unit, such as the first bicycle control unit and/or the second bicycle control unit, configured to control the power supply from the at least one battery to at least one wheel. Preferably, the bicycle comprises a charging device electrically connected or connectable, directly or indirectly, to at least one battery and to at least one bicycle control unit, wherein the charging device comprises at least one charging port configured to co-act with an external charger to transfer electric energy from said external charger via the charging device to at least one battery.

The bicycle may further comprise foot pedals, wherein said pedals are, directly or indirectly, connected to a crank set of the bicycle for propelling the bicycle. In particular, the bicycle is a pedal operable electric bicycle. Moreover, the bicycle comprises preferably at least one electromotor to drive at least one wheel of the bicycle. It is preferred that the bicycle comprises a pedal-operated manpower driven system and an electromotor driven system in parallel to each other, wherein at least one bicycle control unit is configured to control the output of the electromotor driven in response to a pedal depressing force of the manpower driven system.

The present invention is further related to an antenna system and/or an antenna device for use in a bicycle according to the invention. The same benefits apply to the service port according to the invention as have been stipulated with respect to the electric bicycle above. These benefits are therefore incorporated by reference with respect to the antenna system and/or the antenna device.

Preferred embodiments of the invention are set out in the non-limitative set of embodiments presented below:

1. Bicycle, in particular an electric bicycle, comprising:
a bicycle frame,
at least one antenna system at least partially mounted, directly or indirectly, to said bicycle frame, wherein the antenna system comprises at least one antenna device comprising:
   at least one, preferably moulded, support substrate,
   at least one conductive radiator applied onto said substrate,
   a shielding structure covering said at least one conductive radiator, wherein said shielding structure is substantially free of conductive material, and wherein an outer side of the shielding structure facing away from said conductive radiator is at least partially, and preferably substantially entirely, exposed to the environment.

2. Bicycle according to embodiment 1, wherein the outer side of the shielding structure is substantially positioned flush with an adjacent outer surface of the bicycle.

3. Bicycle according to any of the preceding embodiments, wherein at least one antenna device is at least partially mounted directly to said bicycle frame, wherein at least a part of said antenna device is preferably at least partially accommodated by said bicycle frame.

4. Bicycle according to any of the preceding embodiments, wherein a part of at least one antenna device makes integral part of said bicycle frame.

5. Bicycle according to any of the preceding embodiments, wherein the bicycle frame is at least partially composed a conductive material, in particular metal.

6. Bicycle according to any of the preceding embodiments, wherein the bicycle comprises at least one component mounted to said bicycle frame, and wherein at least one antenna device is at least partially mounted directly to said component, wherein at least a part of said antenna device is preferably at least partially accommodated by said component.

7. Bicycle according to embodiment 6, wherein the component is a component chosen from the group consisting of: a headlight, a taillight, a stem, a handlebar, a kickstand, a seat post, a brake lever, a shift lever, a saddle, a bicycle control unit, and a rechargeable battery.

8. Bicycle according to embodiment 6 or 7, wherein at least a part of at least one antenna device makes integral part of said component.

9. Bicycle according to any of the preceding embodiments, wherein the bicycle, in particular the antenna system, comprises a plurality of antenna devices.

10. Bicycle according to any of the preceding embodiments, wherein the bicycle, in particular the antenna system, comprises a plurality of antenna devices, wherein at least two antenna devices are mounted to different parts of the bicycle.

11. Bicycle according to any of the preceding embodiments, wherein the bicycle, in particular the antenna system, comprises a plurality of antenna devices, wherein at least two antenna devices are mounted to the same part of the bicycle.

12. Bicycle according to any of the preceding embodiments, wherein the bicycle, in particular the antenna system, comprises a plurality of antenna devices, wherein at least two antenna devices share a common support substrate, and wherein the radiators of the at least two antenna devices are preferably situated in the same plane.

13. Bicycle according to any of the preceding embodiments, wherein at least one antenna device comprises at least two conductive radiators.

14. Bicycle according to any of the preceding embodiments, wherein at least one conductive radiator of at least one antenna device is formed by a conductive layer.

15. Bicycle according to any of the preceding embodiments, wherein each antenna device comprises a conductive ground plane mounted to the support substrate at a side of the support substrate facing away from the at least one radiator.

16. Bicycle according to any of the preceding embodiments, wherein at least one antenna device is horizontally polarized.

17. Bicycle according to any of the preceding embodiments, wherein at least one antenna device is vertically polarized.

18. Bicycle according to any of the preceding embodiments, wherein each antenna device, in particular each conductive radiator, is connected to a feeding point.

19. Bicycle according to any of the preceding embodiments, wherein at least one radiator of at least one antenna device is flat.

20. Bicycle according to any of the preceding embodiments, wherein at least one radiator of at least one antenna device is curved and/or angular.

21. Bicycle according to any of the preceding embodiments, wherein at least one radiator of at least one antenna device is deposited and/or printed and/or metallized and/or plated onto said substrate.

22. Bicycle according to any of the preceding embodiments, wherein at least one radiator of at least one antenna device is at least partially composed of copper.

23. Bicycle according to any of the preceding embodiments, wherein at least one support substrate of at least one antenna device is a moulded substrate.

24. Bicycle according to embodiment 23, wherein the moulded substrate comprises at least one polymer resin, preferably chosen from the group consisting of: PC, acrylonitrile-butadiene-styrene copolymer (ABS), LCP, and mixtures thereof.

25. Bicycle according to embodiment 23 or 24, wherein said at least one polymer resin incorporates at least one metal-containing substance, preferably a copper-containing substance, and/or preferably a substance chosen from the group consisting of: Cu2(OH)PO4, or a metal oxide containing substance, such as CuO, Cr2O3, or CuO·Cr2O3.

26. Bicycle according to any of the preceding embodiments, wherein at least one antenna device is at least partially made by means of laser direct structuring (LDS).

27. Bicycle according to any of the preceding embodiments, wherein at least one support substrate comprises at least one through-hole via, and/or at least one contact pad, and/or at least one feed line, preferably made by means of laser direct structuring (LDS).

28. Bicycle according to any of the preceding embodiments, wherein the antenna system is configured to operate in at least one wireless communication system selected from the group including: Bluetooth, 2.4 GHz Bluetooth, 2.4 GHz IEEE 802.11b/g, 5 GHZ IEEE802.11a, Hyperlan, IEEE802.11 (WiFi), ultra wide band (UWB), LTE, NFC, WiMAX, ZigBee, ZigBee at 860 MHz, ZigBee at 915 MHz, GPS, GPS at 1.575 GHz, GPS at 1.227 GHz, Galileo, GSM-900, DCS-1800, UMTS, CDMA, DBA, WLAN, WLAN at 2.4 GHz-5 GHZ, PCS 1900, KPCS, WCDMA, DAB, 2.4-2.483 GHz band, and 2.471-2.497 GHz band.

29. Bicycle according to any of the preceding embodiments, wherein at least a part of at least one antenna device is mounted to and/or makes part of a bicycle control unit.

30. Bicycle according to any of the preceding embodiments, wherein the shielding structure comprises a shielding layer, said shielding layer comprises at least one dielectric layer, such as a film, a sticker, and/or a coating, and wherein the shielding layer comprises a laminate of dielectric layers.

31. Bicycle according to any of the preceding embodiments, wherein the bicycle comprises foot pedals, wherein said pedals are, directly or indirectly, connected to a crank set of the bicycle for propelling the bicycle.

32. Bicycle according to any of the preceding embodiments, wherein the bicycle is a pedal operable electric bicycle.

33. Bicycle according to any of the preceding embodiments, wherein the bicycle comprises at least one electromotor to drive at least one wheel of the bicycle.

34. Bicycle according to any of the preceding embodiments, wherein the bicycle comprises a pedal-operated manpower driven system and an electromotor driven system in parallel to each other, wherein at least one bicycle control unit is configured to control the output of the electromotor driven in response to a pedal depressing force of the manpower driven system.

35. Bicycle according to any of the preceding embodiments, wherein at least two, preferably each, of said plurality of antenna devices share said support substrate.

36. Bicycle according to any of the preceding embodiments, wherein the radiators of said antenna devices are deposited and/or printed and/or metallized and/or plated onto said shared support substrate.

37. Bicycle according to any of the preceding embodiments, wherein at least one antenna device forms a moulded interconnect device (MID).

38. Bicycle according to any of the preceding embodiments, wherein said at least two, preferably each, of said plurality of antenna devices sharing said support substrate, together form a single moulded interconnect device (MID).

39. Bicycle according to any of the preceding embodiments, wherein at least one antenna device is at least partially made by means of laser direct structuring (LDS).

40. Bicycle according to any of the preceding embodiments, wherein said at least two, preferably each, of said plurality of antenna devices sharing said support substrate, are at least partially made by means of laser direct structuring (LDS).

41. Bicycle according to any of the preceding embodiments, wherein at least one support substrate comprises at least one through-hole via, and/or at least one contact pad, and/or at least one feed line, preferably made by means of laser direct structuring (LDS).

42. Bicycle according to any of the preceding embodiments, wherein at least one radiator of at least one antenna device is at least partially embedded in the support substrate.

43. Bicycle according to any of the preceding embodiments, wherein said at least two, preferably each, of said plurality of antenna devices sharing the same support substrate are configured to operate in different frequency bands.

44. Bicycle according to any of the preceding embodiments, wherein at least one radiator has a 3D geometry, and wherein, preferably, at least one support structure has a 3D surface onto which said at least one radiator having a matching 3D geometry is applied.

45. Bicycle according to any of the preceding embodiments, wherein at least one, preferably each, radiator has thickness of between 1 and 20 micron.

46. Bicycle according to any of the preceding embodiments, wherein at least one support substrate, preferably said shared support substrate, accommodates at least one speaker device, and wherein said at least one support substrate, preferably said shared support substrate, is provided with a plurality of perforations allowing sound signals emitted by said at least one speaker device to be emitted to an external environment of the bicycle.

47. Bicycle according to any of the preceding embodiments, wherein the bicycle comprises a bicycle control unit, and wherein at least one antenna device is at least partially mounted directly to said control unit and/or integrated with said control unit.

48. Bicycle according to any of the preceding embodiments, wherein at least one support surface is at least partially made of a foamed, polymer-based material.

49. Bicycle according to any of the preceding embodiments, wherein the radiators of said plurality of antenna devices sharing the same support substrate are positioned in line with each other.

50. Antenna system for use in a bicycle according to any of the preceding embodiments.

51. Antenna device for use in a bicycle according to any of embodiments 1-49.

### BRIEF DESCRIPTION OF THE DRAWINGS

The terms Fig., Figs., Figure, and Figures are used interchangeably in the specification to refer to the corresponding figures in the drawings.

The present invention will hereinafter be further elucidated based on the following non-limitative drawings wherein:

FIG. 1 shows a part of a bicycle frame according to the invention;

FIG. 2 shows a cross section of a top tube of the bicycle frame shown in FIG. 1;

FIG. 3 shows a part of a bicycle component comprising an antenna system according to the present invention; and

FIG. 4 shows a schematic overview of a bicycle according to the invention.

### DESCRIPTION OF THE INVENTION

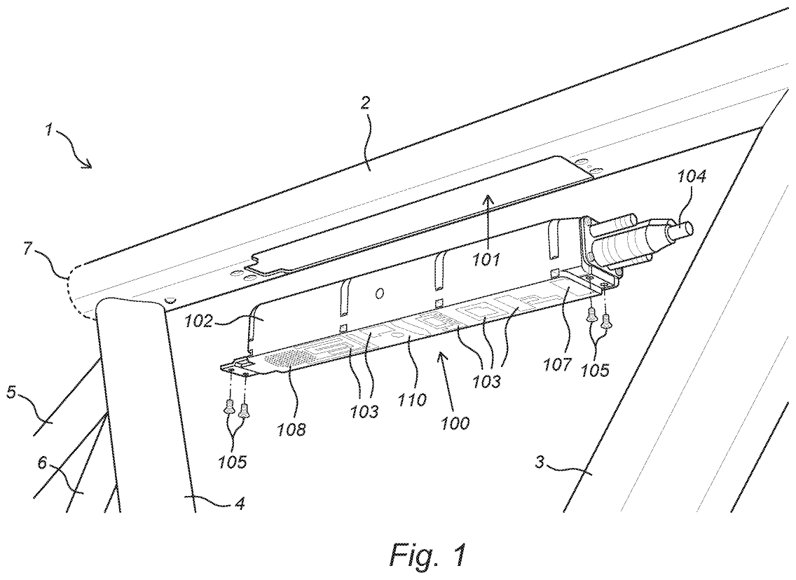

FIG. 1 shows a part of a frame 1 of a bicycle according to the present invention. The frame comprises a top tube 2, which is connected to a bottom tube 3 and a seat tube 4. A pair of seat stays 5 is connected to the seat tube 4. The frame 1 of the bicycle may be seen as a diamond frame. A part 7 of the top tube 2 may extend beyond the seat tube 4, however, this may be a choice of design, and is not as such a technical aspect of the frame 1. The top tube 2 may comprise an opening 101 configured to receive a component 100, in particular a bicycle control unit 100. Said opening 101 may define an accommodating space 101 for accommodating at least a part of the bicycle control unit 100. Said bicycle control unit 100 may comprise a housing 102, which housing may house a plurality of components therein. It may be conceivable that the housing forms at least a part of a support substrate for an antenna system, in particular an antenna device 103. Preferably, the housing forms a support substrate of at least one antenna device which is a moulded substrate 102. Said moulded substrate 102 may e.g., be a moulded component, such as a housing 102 of a bicycle control unit and/or a housing 102 of a rechargeable battery. It is imaginable that the moulded substrate comprises at least one polymer resin, preferably chosen from the group consisting of: PC, acrylonitrile-butadiene-styrene copolymer (ABS), LCP, and mixtures thereof. These polymers have proven to be suitable for the production of the moulded products and additionally functioning as a support substrate. Preferably, said at least one polymer resin incorporates at least one metal-containing substance, preferably a copper-containing substance, and/or preferably a substance chosen from the group consisting of: Cu₂(OH)PO₄, or a metal oxide containing substance, such as CuO, Cr₂O₃, or CuO·Cr₂O₃. This may allow for easy application of the at least one conductive radiator of the antenna device onto the moulded substrate 102. The housing 102 may be attached to the frame 1 by means of fastening elements 105, such as screws 105. The fastening elements 105 may be provided at opposing edges of the housing 102 of the control unit. Preferably, an exposed outer surface 110 of the control unit housing 102 is provided with at least one antenna device 103, preferably a plurality of antenna devices 103. Said antenna devices 103 may provide for connectivity functionalities of the bicycle. At least one connector 104 may connect the control unit 100 to other components of the bicycle. Said exposed outer surface 110 of the control unit 100 may also be provided with a plurality of perforations 108. Said perforations may allow sound signals emitted by at least one speaker device 109 to be emitted from inside the housing 102 to an external environment. Via a ground (GND) the electronic components inside the housing 102 and/or the antenna devices 103 may be grounded, preferably via a central ground system of the bicycle.

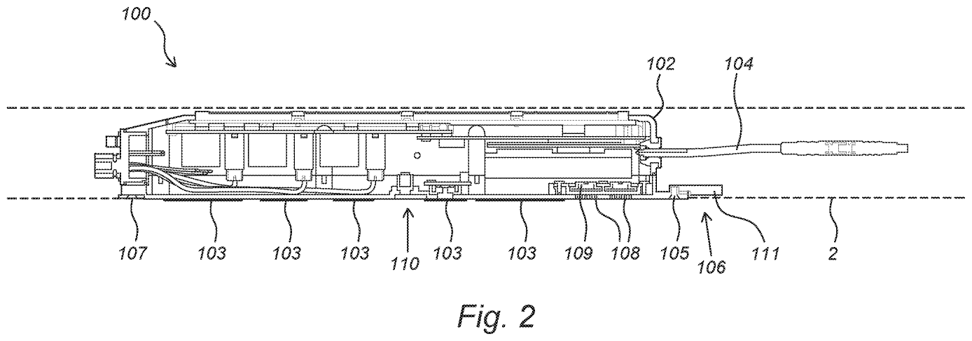

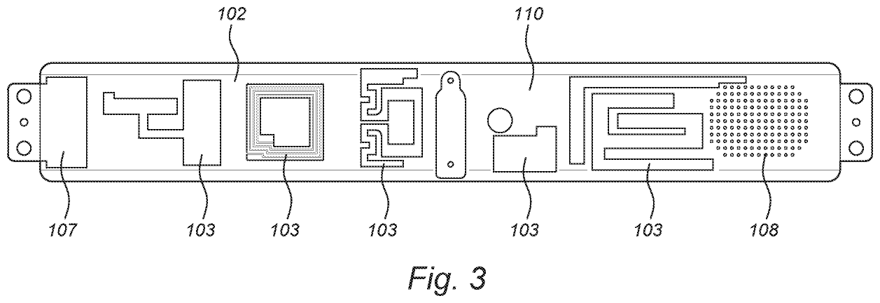

FIG. 2 sows a cross section of a top tube 2 of the bicycle frame 1. The top tube 2 is shown purely schematically to indicated the orientation of the component 100, in particular the bicycle control unit 100 in installed condition. The control unit 100 is mounted, by means of fastening elements 105 to the top tube of the bicycle frame 1. In particular, said fastening elements 105 can may be screwed and/or bolted into a mounting body 111 which may be provided with thread to co-act with a thread of the fastening elements 105. The exposed surface 110 of the control unit 100 is provided with the antenna devices 103. Preferably, said exposed surface 110 is substantially flush 106 with the exterior surface of the top tube 3. Hence, at least one antenna device 103, preferably all antenna devices 103 are substantially flush with said exterior surface of the top tube 2. The ground plane 107 may establish a grounding contact plane in order to prevent shock hazards. It is conceivable that the exposed outer surface 110 may be provided with a thin shielding layer, such as a coating and/or lacquer layer. The antenna devices 103 may be directly or indirectly connected to other electronic components which may be provided inside or outside of the housing 102 of the control unit 100. At least one of said antenna devices 103, e.g., such as shown in FIG. 3, may be a Radio-frequency identification (RFID). Such an antenna may be used for automatically identifying and tracking certain objects, such as a tag. A user may configure a personal smartphone such that said smartphone may function as a tag for the RFID. This may be used for locking and/or unlocking the bicycle based on a detection of the smartphone of the user. RFID tags may be attached to numerous objects, such as clothing, possessions, implanted underneath the skin of a user. The RFID may operate over a predefined frequency range, such as between 120 kHz and 10 GHz, according to the requirements of the application. Preferably, at least one antenna device 103 may be a GPS antenna device.

Preferably at least one antenna device 103 is configured to act as LTE-M antenna 103 and/or as NB-IoT antenna 103, and/or while a fourth antenna device is configured to act as GSM antenna 103. LTE-M (LTE-MTC [Machine Type Communication]), which includes eMTC (enhanced Machine Type Communication), is a type of low power wide area network (LPWAN) radio technology standard (developed by 3GPP) to enable a wide range of cellular devices and services (specifically, for machine-to-machine and Internet of Things applications).

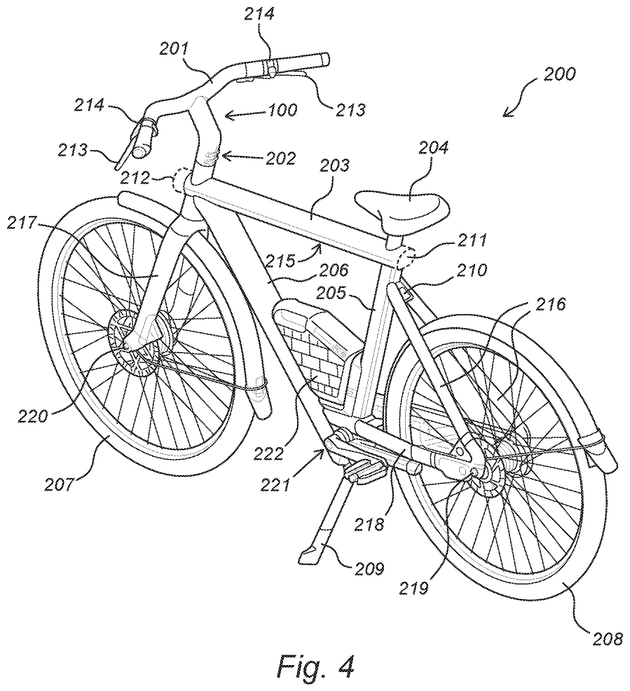

FIG. 4 shows a schematic overview of a bicycle 200 according to the invention. The bicycle 200 comprises a frame comprising a top tube 203, a seat tube 205, a bottom tube 206, a pair of seat stays 216, and a pair of chain stays 218. At the rear axis 219 a rear wheel 208 is rotatably arranged. The rear wheel may be powered by a used via a crank set 221. In order to drive de bicycle 200, the front side of the bicycle may comprise a handlebar 201, which may be rotatable with respect to the head tube 202 of the bicycle. The handlebar 201 may rotate the front wheel 207 which is arranged rotatably on a front axis 220. Said front wheel 207 may be held into place by means of the fork 217 which is rotatably coupled to the handlebar 201 of the bicycle 200. The handlebar 201 may be provided with a brake system 213 for allowing a user to apply a braking force. The handlebar 201 may comprise a first control unit 100, preferably arranged in a stem of the bicycle. Said first control unit may allow the accessory cables of the electronic accessories of the handlebar to be routed at least partially, preferably substantially entirely inside the frame of the bicycle 200. The first control unit 100 allows to reduce the amount of cables running through a steerer tube. One or more optical feedback units 214 may be arranged on and/or in the handlebar 201 for providing the user with optical feedback related to a bicycle status. Inside the bottom tube 206 a primary battery may be arranged for driving at least one electric motor which is arranged in the front axis 220 and/or rear axis 219. Optionally, a secondary battery 222 may be provided for extending the range of the bicycle 200. The primary battery inside the bottom tube 206 and/or the secondary battery 222 may be charged via a charging port 210 of the bicycle 200. The charging port 210 is arranged on a rear side of the bicycle in order to be easily accessible for a user. In this particular embodiment, the charging port 210 is arranged between the pair of seat stays 216 and attached to the seat tube 205 of the bicycle 200. In order for easily connecting the bicycle 200 to an external service device a service port 215 may be provided. In this embodiment the service port 215 is provided on a bottom side of the top tube 203 of the bicycle. Inside the top tube 203 at least one bicycle control unit may be provided. It is imaginable that at least one exposed exterior surface of at least one frame part comprises at least one antenna system. Said antenna system may be directly or indirectly mounted to said bicycle frame 203, 205, 206, 212, 216. The seat tube 205 further accommodates the seat post which may be attached to the saddle 204 of the bicycle 200. In order to increase the visibility of the user of the bicycle 200 during the evening or in the night time, the bicycle 200 may be provided with a front light module 212 and/or a rear light module 211. Said front light module 212 and rear light module 211 may allow for dynamic light patterns and/or for emitting light in at least a left and/or right direction. The bicycle 200 as shown in this figure is merely illustrative for the components thereof. It is explicitly noted that some aspects of the bicycle 200 as shown in this figure may be chosen by way of design. In particular shapes of the light modules 212, 211 may at least partially be shaped by design. Moreover, the shape of the tubes 202, 203, 205, 206 of the bicycle may also at least partially be chosen by way of design. Hence, the aesthetical appearance of the depicted embodiment are matters of design choice and can be varied or eliminated as desired.

The above-described inventive concepts are illustrated by several illustrative embodiments. It is conceivable that individual inventive concepts, including inventive details, may be applied without, in so doing, also applying other details of the described example. It is not necessary to elaborate on examples of all conceivable combinations of the above-described inventive concepts, as a person skilled in the art will understand numerous inventive concepts can be (re)combined in order to arrive at a specific application and/or alternative embodiment.

The ordinal numbers used in this document, like “first”, “second”, and “third” are used only for identification purposes. Hence, the use of expressions like a “second” component, does therefore not necessarily require the co-presence of a “first” component. By “complementary” components is meant that these components are configured to co-act with each other. However, to this end, these components do not necessarily have to have complementary forms. The verb “comprise” and conjugations thereof used in this patent publication are understood to mean not only “comprise”, but are also understood to mean the phrases “contain”, “substantially consist of”, “formed by” and conjugations thereof.

It will be apparent that the invention is not limited to the working examples shown and described herein, but that numerous variants are possible within the scope of the attached claims that will be obvious to a person skilled in the art. The aesthetical appearance and design of the working examples or details thereof, in particular as shown in the appended figures, is not technically determined, unless indicated otherwise, and is merely incorporate to demonstrate and clarify the inventive concept(s) described herein. Hence, the aesthetical appearance of the depicted embodiments are matters of design choice and can be varied or eliminated as desired. The owner of this patent document does moreover not disclaim any other rights that may be lawfully associated with the information disclosed in this document, including but not limited to, copyrights and designs associated with, based upon, and/or derived from the appended figures.

1. A bicycle, comprising:
a bicycle frame,
at least one antenna system at least partially mounted, directly or indirectly, to said bicycle frame, wherein the antenna system comprises a plurality of antenna devices, each antenna device comprising:
at least one; support substrate,
at least one conductive radiator applied onto said substrate,
a shielding structure covering said at least one conductive radiator, wherein said shielding structure is substantially free of conductive material, and wherein an outer side of the shielding structure facing away from said conductive radiator is at least partially exposed to the environment,
wherein at least two; of said plurality of antenna devices share said support substrate, and wherein the radiators of said antenna devices are deposited and/or printed and/or metallized and/or plated onto said shared support substrate.

2. The bicycle according to claim 1, wherein the outer side of the shielding structure is substantially positioned flush with an adjacent outer surface of the bicycle.

3. (canceled)

4. The bicycle ling to claim 1, wherein said at least two of said plurality of antenna devices sharing said support substrate, together form a single moulded interconnect device (MID).

5. The bicycle according to claim 1, wherein at least one antenna device is at least partially made by means of laser direct structuring (LDS) and/or wherein said at least two of said plurality of antenna devices sharing said support substrate, are at least partially made by means of laser direct structuring (LDS) and/or wherein at least one support substrate comprises at least one through-hole via, and/or at least one contact pad, and/or at least one feed line.

6. (canceled)

7. (canceled)

8. The bicycle according to claim 1, wherein at least one radiator of at least one antenna device is at least partially embedded in the support substrate and/or wherein said at least two of said plurality of antenna devices sharing the same support substrate are configured to operate in different frequency bands.

9. (canceled)

10. The bicycle according to claim 1, wherein at least one radiator has a 3D geometry, and wherein at least one support structure has a 3D surface onto which said at least one radiator having a matching 3D geometry is applied and/or wherein at least one radiator has thickness of between 1 and 20 micron.

11. (canceled)

12. The bicycle according to claim 1, wherein at least one support substrate accommodates at least one speaker device, and wherein said at least one support substrate is provided with a plurality of perforations allowing sound signals emitted by said at least one speaker device to be emitted to an external environment of the bicycle.

13. The bicycle according to claim 1, wherein the bicycle comprises a bicycle control unit, and wherein at least one antenna device is at least partially mounted directly to said control unit and/or integrated with said control unit.

14. The bicycle according to claim 1, wherein at least one support surface is at least partially made of a foamed, polymer-based material and/or wherein the radiators of said plurality of antenna devices sharing the same support substrate are positioned in line with each other.

15. (canceled)

16. The bicycle according to claim 1, wherein at least one antenna device is at least partially mounted directly to said bicycle frame, wherein at least a part of said antenna device is at least partially accommodated by said bicycle frame and/or wherein a part of at least one antenna device makes integral part of said bicycle frame and/or wherein the bicycle frame is at least partially composed a conductive material.

17. (canceled)

18. (canceled)

19. The bicycle according to claim 1, wherein the bicycle comprises at least one component mounted to said bicycle frame, and wherein at least one antenna device is at least partially mounted directly to said component, wherein at least a part of said antenna device is at least partially accommodated by said component, wherein the component is a component chosen from the group consisting of: a headlight, a taillight, a stem, a handlebar, a kickstand, a seat post, a break lever, a shift lever, a saddle, a bicycle control unit, and a rechargeable battery and/or, wherein at least a part of at least one antenna device makes integral part of said component.

20. (canceled)

21. (canceled)

22. The bicycle according to claim 1, wherein the bicycle, comprises a plurality of antenna devices.

23. The bicycle according to claim 1, wherein the bicycle comprises a plurality of antenna devices, wherein at least two antenna devices are mounted to different parts of the bicycle or wherein the bicycle comprises a plurality of antenna devices, wherein at least two antenna devices are mounted to the same part of the bicycle.

24. (canceled)

25. The bicycle according to claim 1, wherein the radiators of the at least two antenna devices are situated in the same plane and/or wherein at least one antenna device comprises at least two conductive radiators and/or wherein at least one conductive radiator of at least one antenna device is formed by a conductive layer and/or wherein each antenna device comprises a conductive ground plane mounted to the support substrate at a side of the support substrate facing away from the at least one radiator.

26-28. (canceled)

29. The bicycle according to claim 1, wherein at least one antenna device is horizontally polarized and/or wherein at least one antenna device is vertically polarized and/or wherein each antenna device is connected to a feeding point and/or wherein at least one radiator of at least one antenna device is flat and/or wherein at least one radiator of at least one antenna device is curved and/or angular.

30-33. (canceled)

34. The bicycle according to claim 1, wherein at least one radiator of at least one antenna device is deposited and/or printed and/or metallized and/or plated onto said substrate and/or wherein at least one radiator of at least one antenna device is at least partially composed of copper and/or gold and/or nickel.

35. (canceled)

36. The bicycle according to claim 1, wherein at least one radiator comprises a multi-layered structure comprising a plurality of metal layers and/or wherein at least one support substrate of at least one antenna device is moulded substrate.

37-39. (canceled)

40. The bicycle according to claim 1, wherein the antenna system is configured to operate in at least one wireless communication system selected from the group including: Bluetooth, 2.4 GHz Bluetooth, 2.4 GHZ IEEE 802.11b/g, 5 GHZ IEEE 802.11a, Hyperlan, IEEE802.11 (WiFi), ultra wide band (UWB), LTE, NFC, WiMAX, ZigBee, ZigBee at

860. MHz, ZigBee at 915 MHz, GPS, GPS at 1.575 GHz, GPS at 1.227 GHz, Galileo, GSM-900, DCS-1800, UMTS, CDMA, DBA, WLAN, WLAN at 2.4 GHz-5 GHZ, PCS 1900, KPCS, WCDMA, DAB, 2.4-2.483 GHz band, and 2.471-2.497 GHz band.

41. The bicycle according to claim 1, wherein at least a part of at least one antenna device is mounted to and/or makes part of a bicycle control unit and/or wherein the shielding structure comprises a shielding layer, said shielding laver comprises at least one dielectric layer and wherein the shielding layer comprises a laminate of dielectric layers.

42-46. (canceled)

47. An antenna system or antenna device for use in a bicycle according to claim 1.

48. (canceled)
